(19) United States
(12) Patent Application Publication
(10) Pub. No.: US 2022/0141115 A1
(43) Pub. Date: May 5, 2022

(54) GATEWAY, COMMUNICATION SYSTEM, AND COMMUNICATION METHOD

(71) Applicant: Nippon Telegraph and Telephone Corporation, Tokyo (JP)

(72) Inventor: Shinya KAWANO, Tokyo (JP)

(21) Appl. No.: 17/429,039

(22) PCT Filed: Jan. 30, 2020
(86) PCT No.: PCT/JP2020/003568

§ 371 Date: Aug. 6, 2021

(30) Foreign Application Priority Data
Feb. 13, 2019 (JP) 2019-024005

(51) Int. Cl. H04L 43/10; H04L 43/12; H04L 43/04; H04L 12/46

(52) U.S. Cl. CPC H04L 43/10; H04L 12/46; H04L 43/04; H04L 43/12

(57) ABSTRACT

An IoT device accommodation GW includes an alive monitoring time management unit, an alive monitoring reception amount management unit, and a communication unit. The alive monitoring time management unit sets, for each IoT device, a transmission time of an alive monitoring message to the gateway. The alive monitoring reception amount management unit acquires a planned reception number of alive monitoring messages by the IoT devices per unit time based on a setting content by the alive monitoring time management unit. The alive monitoring time management unit changes the transmission time of the alive monitoring message of any IoT device in a case where the acquired planned reception number exceeds an allowable reception number of alive monitoring messages. The communication unit transmits the transmission time set by or the transmission time changed by the alive monitoring time management unit to the IoT device.

### CROSS-REFERENCE TO RELATED APPLICATIONS

This application is a National Stage application under 35 U.S.C. § 371 of International Application No. PCT/JP2020/003568, having an International Filing Date of Jan. 30, 2020, which claims priority to Japanese Application Serial No. 2019-024005, filed on Feb. 13, 2019. The disclosure of the prior application is considered part of the disclosure of this application, and is incorporated in its entirety into this application.

### TECHNICAL FIELD

The present invention relates to a gateway, a communication system, and a communication method.

### BACKGROUND ART

In recent years, the number of IoT devices has been increasing in response to diversification of IoT (Internet of things) devices connected with networks such as network cameras and televisions. In related art, as a method of alive monitoring of IoT devices, there has been a method in which an IoT device regularly transmits an alive monitoring signal to an IoT device accommodation gateway (GW) (see Non-Patent Literature 1). Further, there has been a method in which an IoT device accommodation GW regularly transmits an alive monitoring signal to an IoT device (see Non-Patent Literature 2).

### CITATION LIST

### Non-Patent Literature

Non-Patent Literature 1: <Special Feature> Found from Experiments! Real Capability of LPWA (column 2), [online], [retrieved Dec. 20, 2018], Internet <URL: https://businessnetwork.jp/Detail/tabid/65/artid/5450/Default.aspx>
Non-Patent Literature 2: AWS IoT Device Alive Monitoring, [online], [retrieved Dec. 20, 2018], Internet <URL: https://qiita.com/yokobonbon/items/a80952f5ecde3f4ed628>

### SUMMARY OF THE INVENTION

### Technical Problem

Due to an increase in the number of IoT devices, the number of data signals of IoT devices increases, and alive monitoring signals for devices increase. There has been a problem that this increases a load on an IoT device accommodation GW due to alive monitoring.

For example, in a method disclosed in Non-Patent Literature 1, an IoT device regularly transmits an alive monitoring signal to an IoT device accommodation GW. Thus, in the method disclosed in Non-Patent Literature 1, the alive monitoring signal is transmitted even in a case where a high load is applied to a system of the IoT device accommodation GW, and a load on IoT device accommodation GW increases.

Further, in the method disclosed in Non-Patent Literature 2, because an IoT device accommodation GW regularly transmits an alive monitoring signal to an IoT device, the method may not handle a case where the IoT device is in a sleep state (sleep due to a power saving function) and may thus not receive the signal.

The present invention has been made in consideration of the above circumstance, and an object is to provide a gateway, a communication system, and a communication method that realize appropriate alive monitoring even in a case where an IoT device is in a sleep state and enable reduction in a load on an IoT device accommodation GW due to alive monitoring.

### Means for Solving the Problem

To solve the above-described problem and achieve the object, a gateway according to the present invention is a gateway accommodating a plurality of IoT devices, the gateway including: a first setting unit setting, for each of the IoT devices, a transmission time of an alive monitoring message to the gateway; a first acquisition unit acquiring a planned reception number of alive monitoring messages by the IoT devices per unit time based on a setting content by the first setting unit; a change unit changing the transmission time of the alive monitoring message of any IoT device in a case where the acquired planned reception number exceeds an allowable reception number of alive monitoring messages; and a communication unit transmitting the transmission time set by the first setting unit or the transmission time changed by the change unit to the IoT device.

Further, a communication system according to the present invention is a communication system including: a plurality of IoT devices; and a gateway accommodating the plurality of IoT devices, in which the gateway includes: a first setting unit setting, for each of the IoT devices, a transmission time of an alive monitoring message to the gateway; a first acquisition unit acquiring a planned reception number of alive monitoring messages by the IoT devices per unit time based on a setting content by the first setting unit; a change unit changing the transmission time of the alive monitoring message of any IoT device in a case where the acquired planned reception number exceeds an allowable reception number of alive monitoring messages; and a first communication unit transmitting the transmission time set by the first setting unit or the transmission time changed by the change unit to the IoT device, and in which the IoT device includes a second communication unit transmitting a message to the gateway in accordance with a monitoring cycle transmitted by the first communication unit.

### Effects of the Invention

The present invention realizes appropriate alive monitoring even in a case where an IoT device is in a sleep state, and enables reduction in a load on an IoT device accommodation GW due to alive monitoring.

### BRIEF DESCRIPTION OF DRAWINGS

FIG. 1 is a diagram that illustrates one example of a configuration of a communication system in a first embodiment.

FIG. 2 is a diagram illustrating one example of a configuration of an IoT device illustrated in FIG. 1.

FIG. 3 is a diagram illustrating one example of a configuration of an IoT device accommodation GW illustrated in FIG. 1.

FIG. 4 is a diagram explaining time management by an alive monitoring reception timer.

FIG. 5 is a diagram explaining management of a planned reception number of alive monitoring messages by an alive monitoring reception amount management unit.

FIG. 6 is a sequence diagram illustrating one example of processing procedures of an alive monitoring process according to the first embodiment.

FIG. 7 is a flowchart illustrating processing procedures of a transmission time setting process of the alive monitoring message, the transmission time setting process being illustrated in FIG. 6.

FIG. 8 is a sequence diagram illustrating one example of processing procedures of the alive monitoring process according to the first embodiment.

FIG. 9 is a sequence diagram illustrating one example of the processing procedures of the alive monitoring process according to the first embodiment.

FIG. 10 is a diagram illustrating one example of a configuration of an IoT device accommodation GW according to a second embodiment.

FIG. 11 is a diagram explaining a history of transaction numbers acquired by a transaction management unit.

FIG. 12 is a diagram illustrating allowable reception numbers of alive monitoring messages in unit times, the allowable reception numbers being obtained by an allowable number setting unit.

FIG. 13 is a sequence diagram illustrating one example of processing procedures of an alive monitoring process according to the second embodiment.

FIG. 14 is a flowchart illustrating processing procedures of an allowable number setting process illustrated in FIG. 13.

FIG. 15 is a diagram illustrating one example of a computer executing programs and thereby realizing an apparatus configuring the communication system of the first or second embodiment.

### DESCRIPTION OF EMBODIMENTS

Embodiments of the present invention will hereinafter be described in detail with reference to drawings. Note that the present invention is not limited by the embodiments. Further, as for denotation in the drawings, the same reference characters will be given to illustrate the same elements.

### First Embodiment

[System Configuration]

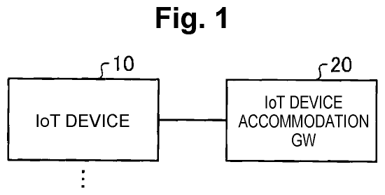

FIG. 1 is a diagram illustrating an outline configuration of a communication system according to a first embodiment. As illustrated in FIG. 1, the communication system according to the first embodiment has a plurality of IoT devices 10 and an IoT device accommodation GW 20.

The IoT device 10 is a communication apparatus provided to each kind of sensor, a camera, a home electric appliance, an automobile, a drone, or the like, for example, and being capable of communication. The IoT device 10 is accommodated in the IoT device accommodation GW 20. The IoT device 10 transmits an alive monitoring message to the IoT device accommodation GW 20 in accordance with a monitoring cycle set by the IoT device accommodation GW 20.

The IoT device accommodation GW 20 accommodates a plurality of IoT devices 10. The IoT device accommodation GW 20 sets the monitoring cycle for the IoT device 10, causes the IoT device 10 to transmit the alive monitoring message in the set monitoring cycle, and thereby performs alive monitoring of the IoT device 10. Specifically, in a case where data or the alive monitoring message is received from the IoT device, the IoT device accommodation GW 20 notifies a transmission time of the alive monitoring message to the IoT device 10. The IoT device accommodation GW 20 performs communication with an upper server, for example, a server of a service provider, via a network.

[Configuration of IoT Device]

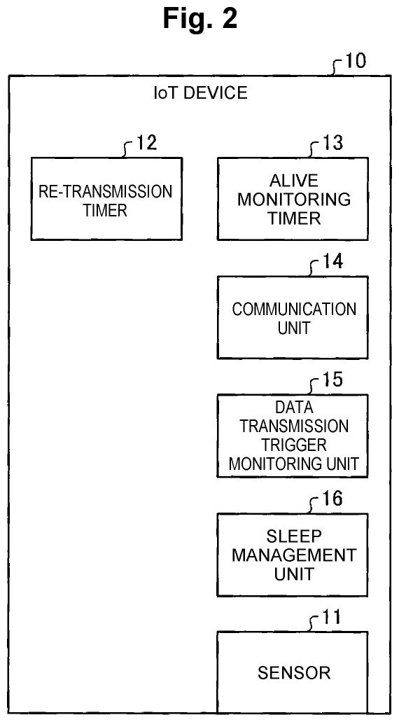

Next, a configuration of the IoT device 10 will be described. FIG. 2 is a diagram illustrating one example of the configuration of the IoT device 10 illustrated in FIG. 1. As illustrated in FIG. 2, the IoT device 10 has a sensor 11, a re-transmission timer 12, an alive monitoring timer 13, a communication unit 14 (second communication unit), a data transmission trigger monitoring unit 15, and a sleep management unit 16 (management unit). The IoT device 10 is realized by a sensor, a memory, a CPU, and so forth, for example.

The sensor 11 is a temperature sensor, for example. The sensor 11 outputs detected data to the data transmission trigger monitoring unit 15.

The re-transmission timer 12 is a timer for performing re-transmission in a case where an acknowledgment from the IoT device accommodation GW 20 is not made to a message that the IoT device 10 transmits to the IoT device accommodation GW 20.

The alive monitoring timer 13 manages timer data of the alive monitoring message. The timer data are data indicating the transmission time of the alive monitoring message, the transmission time being received from the IoT device accommodation GW 20. When the transmission time of the alive monitoring message, the transmission time being set by the IoT device accommodation GW 20, is reached, the communication unit 14 is caused to transmit the alive monitoring message.

The communication unit 14 performs communication with the IoT device accommodation GW 20. The communication unit 14 receives the acknowledgment from the IoT device accommodation GW 20. The acknowledgment includes the transmission time of the alive monitoring message. The communication unit 14 transmits the data detected by the sensor 11 or the alive monitoring message to the IoT device accommodation GW 20.

The data transmission trigger monitoring unit 15 performs trigger management for transmitting the data detected by the sensor 11. The data transmission trigger monitoring unit 15 is a timer, for example, and causes the communication unit 14 to transmit the data when a predetermined time elapses after previous data transmission. Further, the data transmission trigger monitoring unit 15 performs threshold value monitoring for the data detected by the sensor 11 and causes the communication unit 14 to transmit the detected data in a case where the value of the data exceeds a threshold value.

The sleep management unit 16 causes a communication function and so forth to sleep in a period in which no data communication is made. The sleep management unit 16 attempts power saving by causing the communication function and so forth to sleep from after reception of the acknowledgment from the IoT device accommodation GW 20 to the transmission time of the alive monitoring message, the transmission time being indicated by the acknowledgment.

[Configuration of IoT Device Accommodation GW]

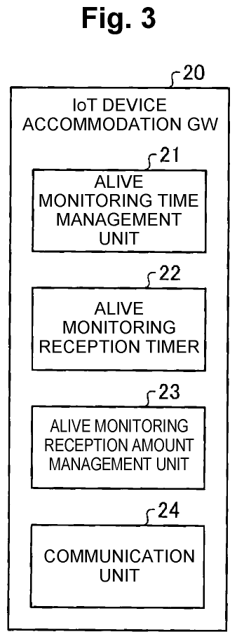

FIG. 3 is a diagram illustrating one example of a configuration of the IoT device accommodation GW 20 illustrated in FIG. 1. As illustrated in FIG. 2, the IoT device accommodation GW 20 has an alive monitoring time management unit 21 (first setting unit and change unit), an alive monitoring reception timer 22, an alive monitoring reception amount management unit 23 (first acquisition unit), and a communication unit 24 (first communication unit).

The alive monitoring time management unit 21 manages an alive monitoring cycle for each of the IoT devices 10. For each of the IoT devices 10, an alive monitoring time of a default value is registered in advance in the alive monitoring time management unit 21. For example, for a certain IoT device 10, one day as the default value is set as a monitoring cycle. The monitoring cycle may be set in advance by a system administrator or may be set by a user when a device is registered in a system. Further, the alive monitoring time management unit 21 sets, for the IoT device 10, the transmission time of the alive monitoring message to the IoT device accommodation GW 20. Specifically, in a case where the data or the alive monitoring message is received from the IoT device 10, the alive monitoring time management unit 21 transmits the acknowledgment including the transmission time of the alive monitoring message to this IoT device 10.

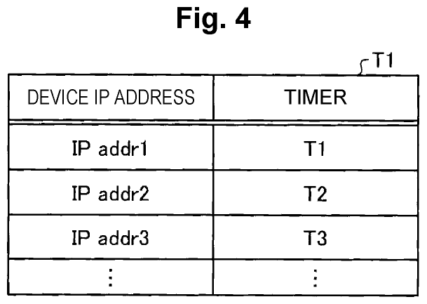

The alive monitoring reception timer 22 is a timer for managing an elapsing time from data reception by the IoT device 10 for each of the IoT devices 10. FIG. 4 is a diagram explaining time management by the alive monitoring reception timer 22.

As indicated in a table T1 of FIG. 4, the alive monitoring reception timer 22 performs management by associating IP addresses of the IoT devices 10 with timer values. The alive monitoring time management unit 21 sets the value of a timer of each of the IoT devices 10 in accordance with the alive monitoring time registered in advance for each of the IoT devices 10. For example, a timer value of “T1” is set for the IoT device 10 having an IP address of “IP addr 1”. The alive monitoring reception timer 22 resets the timer corresponding to the IoT device 10 at the time of data reception from the IoT device 10, and performs a decrement in accordance with a lapse of time. Alternatively, the alive monitoring reception timer 22 resets the timer corresponding to the IoT device 10 to zero at the time of data reception from the IoT device 10 and performs an increment.

Based on a setting content by the alive monitoring time management unit 21, the alive monitoring reception amount management unit 23 acquires and manages a planned reception number of alive monitoring messages by the IoT devices 10 per unit time. Because the alive monitoring time management unit 21 sets, for each of the IoT devices, the transmission time of the alive monitoring message to the IoT device accommodation GW 20, the alive monitoring reception amount management unit 23 manages the planned reception number of alive monitoring messages for each of the unit times based on this setting content.

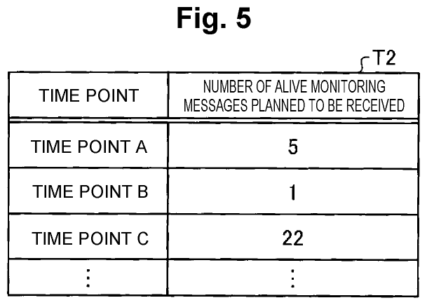

FIG. 5 is a diagram explaining management of the planned reception number of alive monitoring messages by the alive monitoring reception amount management unit 23. As indicated in a table T2 of FIG. 5, the alive monitoring reception amount management unit 23 performs management by associating a unit time (for example, 10 minutes) with the number of alive monitoring messages planned to be received. The alive monitoring reception amount management unit 23 obtains the numbers of alive monitoring messages planned to be received “5”, “1”, and “22” for respective unit times of a time point A, a time point B, and a time point C, and associates the numbers of alive monitoring messages with the respective time points.

Further, in a case where the planned reception number of alive monitoring messages per unit time, the planned reception number being acquired by the alive monitoring reception amount management unit 23, exceeds a predetermined allowable reception number, the alive monitoring time management unit 21 changes the transmission time of the alive monitoring message of any IoT device 10. The predetermined allowable reception number is set in advance corresponding to resources or the like allocated for the alive monitoring in the IoT device accommodation GW 20. The predetermined allowable reception number is 1,000, for example.

For example, the unit time is defined in advance regardless of the IoT devices 10 and is 10 minutes or the like. A description will be made about, as an example, a case where the unit time is 10 minutes and the next unit time is from “9:00” to “9:10”. In a case where the number of alive monitoring messages planned to be received from “9:00” to “9:10” exceeds the allowable reception number, the alive monitoring reception amount management unit 23 further obtains the number of alive monitoring messages planned to be received from “9:10” to “9:20” which is the next unit time. In a case where the number of alive monitoring messages planned to be received from “9:10” to “9:20” becomes the allowable reception number or less, the alive monitoring time management unit 21 changes the transmission time point of the next alive monitoring messages from “9:10” to “9:20” for the IoT devices 10 that exceed the allowable reception number.

On the other hand, in a case where the number of alive monitoring messages planned to be received from “9:10” to “9:20” exceeds the allowable reception number, the alive monitoring reception amount management unit 23 further obtains the number of alive monitoring messages planned to be received from “9:20” to “9:30” which is the next unit time. In a case where the number of alive monitoring messages planned to be received from “9:20” to “9:30” becomes the allowable number or less, the alive monitoring time management unit 21 changes the transmission time point of the next alive monitoring messages from “9:10” to “9:20” for the IoT devices 10 that exceed the allowable reception number.

As described above, in a case where the planned reception number of alive monitoring messages per unit time exceeds the predetermined allowable reception number, the alive monitoring reception amount management unit 23 acquires the planned reception number of alive monitoring messages by the IoT devices 10 for each of the subsequent unit times. Further, the alive monitoring time management unit 21 changes the transmission time of the alive monitoring message of any IoT device such that the transmission time corresponds to the unit time in which the planned reception number of alive monitoring messages, the planned reception number being acquired by the alive monitoring reception amount management unit 23, becomes the allowable reception number or less.

The communication unit 24 performs communication with the IoT device 10. The communication unit 24 receives the data detected by the sensor 11 or the alive monitoring message from the IoT device 10. The communication unit 24 transmits the acknowledgment to the IoT device 10. The acknowledgment includes the transmission time of the alive monitoring message, the transmission time being set or changed by the alive monitoring time management unit 21.

[Processing Procedures of Alive Monitoring Process]

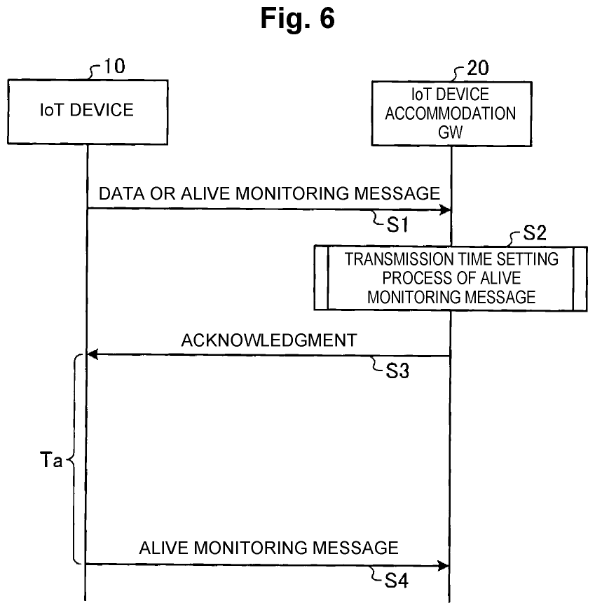

Next, a description will be made about processing procedures of the alive monitoring process in communication processes in the communication system illustrated in FIG. 1. FIG. 6 is a sequence diagram illustrating one example of the processing procedures of the alive monitoring process according to the first embodiment.

The IoT device 10 transmits the data or the alive monitoring message to the IoT device accommodation GW 20 (step S1). The IoT device 10 transmits the data to the IoT device accommodation GW 20 in accordance with the trigger management by the data transmission trigger monitoring unit 15. Alternatively, the IoT device 10 transmits alive monitoring data to the IoT device accommodation GW 20 when the alive monitoring timer 13 expires.

When the data or the alive monitoring message is received, the IoT device accommodation GW 20 performs a transmission time setting process of the alive monitoring message for setting the transmission time of the alive monitoring message for this IoT device 10 (step S2). The IoT device accommodation GW 20 transmits the acknowledgment including the set transmission time of the alive monitoring message to the IoT device 10 (step S3). The IoT device accommodation GW 20 may transmit, as the transmission time of the alive monitoring message, a period (monitoring cycle) Ta from a time of the previous transmission of the alive monitoring message to the next transmission or may transmit the transmission time point of the next alive monitoring message.

When the acknowledgment is received, the IoT device 10 transmits the alive monitoring message to the IoT device accommodation GW 20 when the period Ta elapses (step S4). Note that in a case where the IoT device 10 transmits the data before the period Ta elapses after the time of the previous transmission of the alive monitoring message, this data transmission may be used as the alive monitoring.

[Processing Procedures of Transmission Time Setting Process of Alive Monitoring Message]

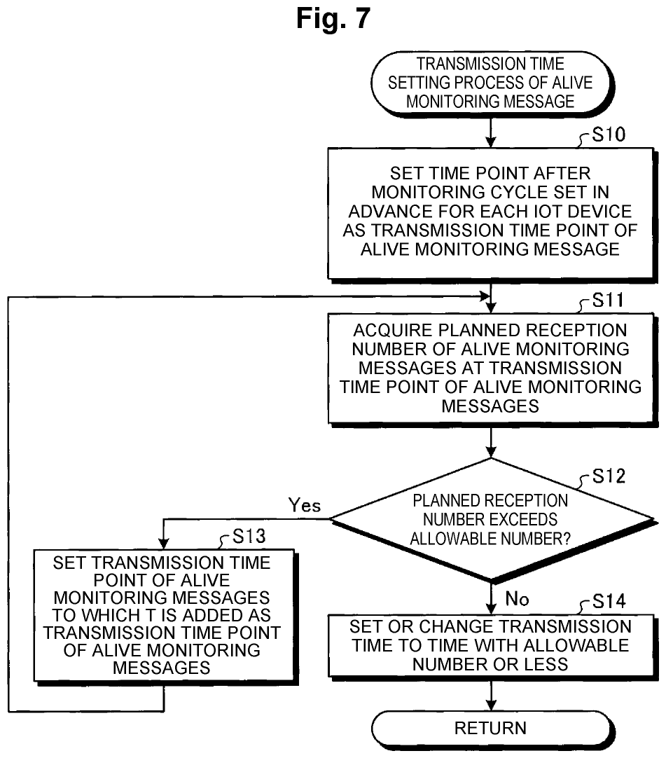

Next, a description will be made about processing procedures of the transmission time setting process (step S2) of the alive monitoring message, the transmission time setting process being illustrated in FIG. 6. FIG. 7 is a flowchart illustrating the processing procedures of the transmission time setting process of the alive monitoring message illustrated in FIG. 6.

First, in the IoT device accommodation GW 20, the alive monitoring time management unit 21 sets a time point after the monitoring cycle set in advance for each of the IoT devices as a transmission time point of the alive monitoring message (step S10). The alive monitoring reception amount management unit 23 acquires the planned reception number of alive monitoring messages at the transmission time point of the alive monitoring messages (step S11). Then, the alive monitoring time management unit 21 determines whether or not the planned reception number acquired in step S11 exceeds the predetermined allowable reception number (step S12).

A description will be made about a case where the alive monitoring time management unit 21 determines that the planned reception number acquired in step S11 is the predetermined allowable reception number or less (step S12: No). In this case, the alive monitoring time management unit 21 sets the time described in the following as the transmission time of the alive monitoring messages (step S14). The above-described time is the time that corresponds to the unit time in which the planned reception number of alive monitoring messages, the planned reception number being acquired by the alive monitoring reception amount management unit 23, becomes the allowable reception number or less. Then, the alive monitoring reception amount management unit 23 increments the planned reception number of alive monitoring messages of this unit time.

A description will be made about a case where the alive monitoring time management unit 21, on the other hand, determines that the planned reception number acquired in step S11 exceeds the predetermined allowable reception number (step S12: Yes). In this case, the alive monitoring reception amount management unit 23 sets the transmission time point of the alive monitoring messages to which T is added as the transmission time point of the alive monitoring messages (step S13). Then, returning to step S11, the alive monitoring reception amount management unit 23 acquires the planned reception number of alive monitoring messages at the transmission time point of the alive monitoring messages. Then, in a case where it is determined that the planned reception number acquired in step S13 is the predetermined allowable number or less (step S12: No), the alive monitoring time management unit 21 sets the time described in the following as the transmission time of the alive monitoring messages (step S14). The above-described time is the time in which the planned reception number of alive monitoring messages, the planned reception number being acquired by the alive monitoring reception amount management unit 23, becomes the allowable reception number or less. Then, the alive monitoring reception amount management unit 23 increments the planned reception number of alive monitoring messages of this unit time.

The IoT device accommodation GW 20 acquires the planned reception number of alive monitoring messages by shifting the time by the unit time. Furthermore, the IoT device accommodation GW 20 changes the transmission times of the alive monitoring messages of the IoT devices 10 such that the transmission times correspond to the time in which the acquired planned reception number becomes the predetermined allowable reception number or less. The IoT devices 10 as targets of change of the transmission times of the alive monitoring messages are the IoT devices 10 as transmission sources of messages exceeding the allowable reception number of the planned reception number of alive monitoring messages acquired in step S11.

[Effects of First Embodiment]

As described above, in this first embodiment, the IoT device 10 has no signal reception in the period T until the indicated transmission time of the alive monitoring message and may thus cause the communication function to be in a sleep state. In other words, because the IoT device 10 retains a transmission timing of the alive monitoring message, the IoT device 10 does not always have to be in a state of being capable of receiving a message from the IoT device accommodation GW 20, and sleep becomes possible.

Further, in this first embodiment, the IoT device accommodation GW 20 sets the monitoring cycle for each of the IoT devices 10. That is, the IoT device accommodation GW 20 may freely set the transmission time of the alive monitoring message for each of the IoT devices 10. In other words, the IoT device accommodation GW 20 may spread the transmission timings of the alive monitoring messages for each of the IoT devices 10 such that reception timings of the alive monitoring messages do not overlap with each other.

Furthermore, in this first embodiment, the IoT device accommodation GW 20 checks the planned reception number of alive monitoring messages in each of the unit times. Further, in a case where an allowable number for the IoT device accommodation GW 20 is exceeded, the IoT device accommodation GW 20 changes the transmission times of the alive monitoring messages to later times for the IoT devices 10 as the transmission sources of exceeding messages.

Thus, in this first embodiment, because the alive monitoring messages exceeding an allowable amount of the IoT device accommodation GW 20 are not transmitted, concentration of the alive monitoring messages to the IoT device accommodation GW 20 may be prevented.

Consequently, according to this first embodiment, a load on the IoT device accommodation GW 20 due to the alive monitoring may be spread, and reduction in the load on the IoT device accommodation GW 20 due to the alive monitoring is enabled.

Note that in this first embodiment, in a case where the allowable number for the IoT device accommodation GW 20 is exceeded, the IoT device accommodation GW 20 may change the transmission times of the alive monitoring messages to earlier times for the IoT devices 10 as the transmission sources of exceeding messages.

[One Example of Processing Procedures of Alive Monitoring Process]

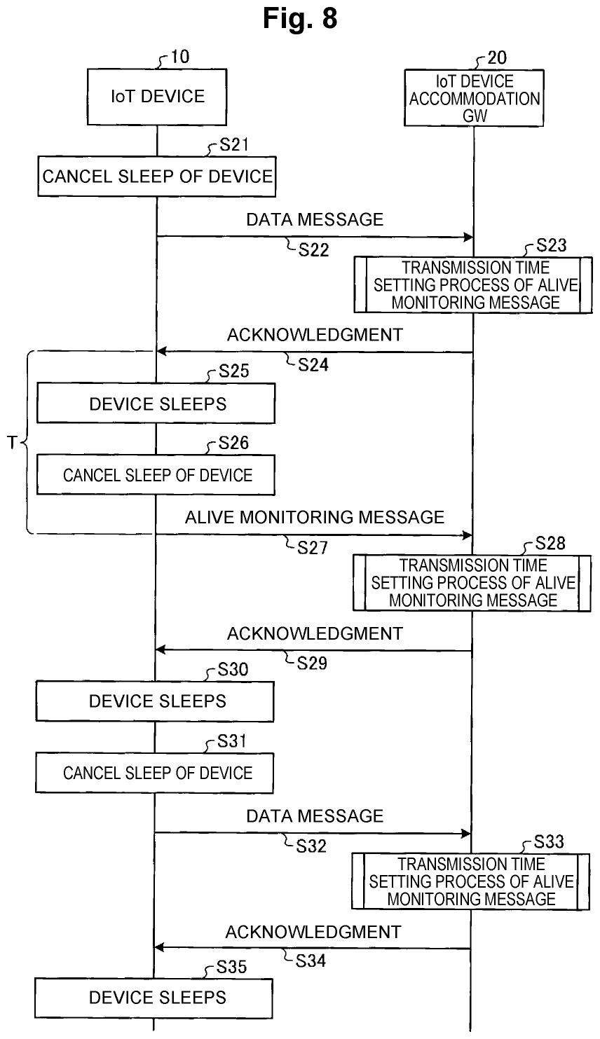

Next, a description will be made about one example of the alive monitoring process in the communication system illustrated in FIG. 1. FIG. 8 is a sequence diagram illustrating one example of processing procedures of the alive monitoring process according to the first embodiment. In FIG. 8, a description will be made about a process in a case where the IoT device 10 transmits a data message to the IoT device accommodation GW 20.

The IoT device 10 cancels sleep in accordance with the trigger management by the data transmission trigger monitoring unit 15 (step S21) and transmits the data message to the IoT device accommodation GW 20 (step S22).

When the data message is received, similarly to step S2, the IoT device accommodation GW 20 sets the transmission time of the alive monitoring message for this IoT device 10 (step S23). The IoT device accommodation GW 20 transmits the acknowledgment including the set transmission time of the alive monitoring message to the IoT device 10 (step S24).

The IoT device 10 sleeps when the acknowledgment is received (step S25), cancels sleep when the period Ta elapses (step S26), and transmits the alive monitoring message to the IoT device accommodation GW 20 (step S27).

When the alive monitoring message is received, similarly to step S2, the IoT device accommodation GW 20 sets the transmission time of the alive monitoring message for this IoT device 10 (step S28). The IoT device accommodation GW 20 transmits the acknowledgment including the set transmission time of the alive monitoring message to the IoT device 10 (step S29).

When the acknowledgment is received, the IoT device 10 sleeps (step S30). In a case where the data are transmitted before a set period elapses after the previous transmission of the alive monitoring message, the IoT device 10 cancels sleep (step S31) and transmits the data message as the alive monitoring (step S32).

When the data message is received, similarly to step S2, the IoT device accommodation GW 20 sets the transmission time of the alive monitoring message for this IoT device 10 (step S33). The IoT device accommodation GW 20 transmits the acknowledgment including the set transmission time of the alive monitoring message to the IoT device 10 (step S34). When the acknowledgment is received, the IoT device 10 sleeps (step S35).

[Another Example of Processing Procedures of Alive Monitoring Process]

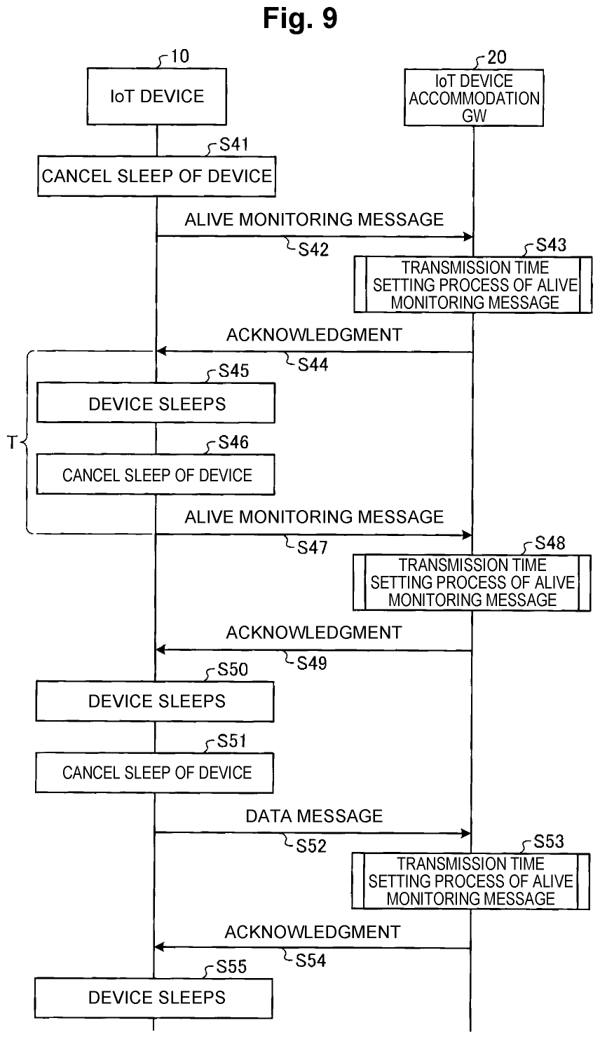

Next, a description will be made about another example of the alive monitoring process in the communication system illustrated in FIG. 1. FIG. 9 is a sequence diagram illustrating one example of the processing procedures of the alive monitoring process according to the first embodiment. In FIG. 9, a description will be made about a process in a case where the IoT device 10 transmits the alive monitoring message to the IoT device accommodation GW 20.

The IoT device 10 cancels sleep in response to expiration of the alive monitoring timer 13 (step S41) and transmits the alive monitoring message to the IoT device accommodation GW 20 (step S42).

When the data message is received, similarly to step S2, the IoT device accommodation GW 20 sets the transmission time of the alive monitoring message for this IoT device 10 (step S43) and transmits the acknowledgment including the set transmission time of the alive monitoring message to the IoT device 10 (step S44). Step S45 to step S55 illustrated in FIG. 8 are the same processes as step S25 to step S35 illustrated in FIG. 7.

### Second Embodiment

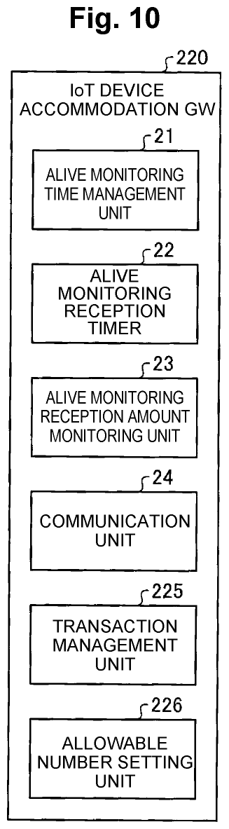

Next, a second embodiment will be described. FIG. 10 is a diagram illustrating one example of a configuration of an IoT device accommodation GW according to the second embodiment. A communication system according to the second embodiment has an IoT device accommodation GW 220 illustrated in FIG. 10 instead of the IoT device accommodation GW 20.

[Configuration of IoT Device Accommodation GW] As illustrated in FIG. 10, compared to the IoT device accommodation GW 20, the IoT device accommodation GW 220 further has a transaction management unit 225 (second acquisition unit) and an allowable number setting unit 226 (second setting unit).

The transaction management unit 225 acquires a history of a transaction number of the IoT devices 10 for each of the unit times. The history of the transaction number is a history of the number of transmitted and received messages in the IoT device accommodation GW 220 in each of the unit times.

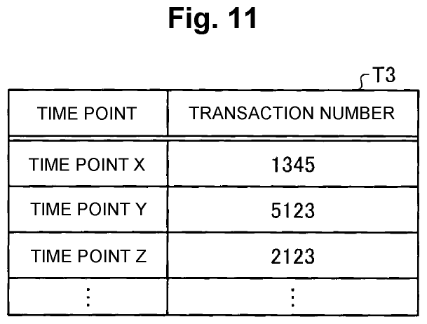

FIG. 11 is a diagram explaining the history of the transaction numbers acquired by the transaction management unit 225. As indicated in a table T3 of FIG. 11, the transaction management unit 225 manages the unit time and the transaction number for each unit time (for example, 10 minutes). The transaction management unit 225 acquires transaction numbers “1345”, “5123”, and “2123” for each of the time points corresponding to the respective unit times of a time point X, a time point Y, and a time point Z, and associates the transaction numbers with the respective time points.

The allowable number setting unit 226 predicts the transaction number in the next unit time based on the history of the transaction numbers acquired by the transaction management unit 225. The allowable number setting unit 226 predicts the transaction number in the next unit time as a target of setting of the allowable reception number from the history of the transaction number per day or per week.

Further, the allowable number setting unit 226 sets the allowable reception number of alive monitoring messages in the next unit time based on a maximum allowable number of the transaction number per unit time in the IoT device accommodation GW 220 and the predicted transaction number. The allowable number setting unit 226 obtains the allowable reception number of alive monitoring messages in the next unit time by using an expression (1), for example.

P=(Dm−Df)×Rt (1)

A term P denotes the allowable reception number of alive monitoring messages in the next unit time. A term Dm denotes the maximum allowable number of the transaction number per unit time in the IoT device accommodation GW 220. A term Df denotes the transaction number predicted by the allowable number setting unit 226. A term Rt denotes the ratio of resources assigned to the alive monitoring in the IoT device accommodation GW 220. The values of Dm and Rt are set in advance and are also capable of being changed. For example, in a case where Dm is 10,000, Df is 8,000, and Rt is 0.1, P becomes 200.

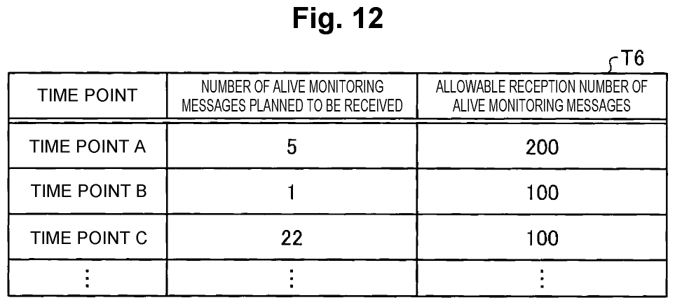

The allowable number setting unit 226 may obtain the allowable reception numbers of alive monitoring messages in subsequent unit times for each of the unit times. FIG. 12 is a diagram illustrating the allowable reception numbers of alive monitoring messages in the unit times, the allowable reception numbers being obtained by the allowable number setting unit 226. As indicated in a table T6 of FIG. 12, the allowable number setting unit 226 obtains the allowable reception number of alive monitoring messages in the unit time for each unit time (for example, 10 minutes). The allowable number setting unit 226 obtains the allowable reception numbers of alive monitoring messages “200”, “100”, and “100” for each of the time points corresponding to the respective unit times of a time point A, a time point B, and a time point C.

The allowable number setting unit 226 outputs the allowable reception number of alive monitoring messages for each of the unit times to the alive monitoring time management unit 21. The alive monitoring time management unit 21 sets or changes the transmission time of the alive monitoring message of the IoT device 10 by using the allowable reception number of alive monitoring messages for each of the unit times, the allowable reception number being input from the allowable number setting unit 226. In other words, the alive monitoring time management unit 21 compares the number of alive monitoring messages planned to be received (see the middle column in the table T6) with the allowable reception number of alive monitoring messages for each of the unit times (see the left column in the table T6), the allowable reception number being set by the allowable number setting unit 226, and thereby sets or changes the transmission time of the alive monitoring message of the IoT device 10.

[Processing Procedures of Alive Monitoring Process]

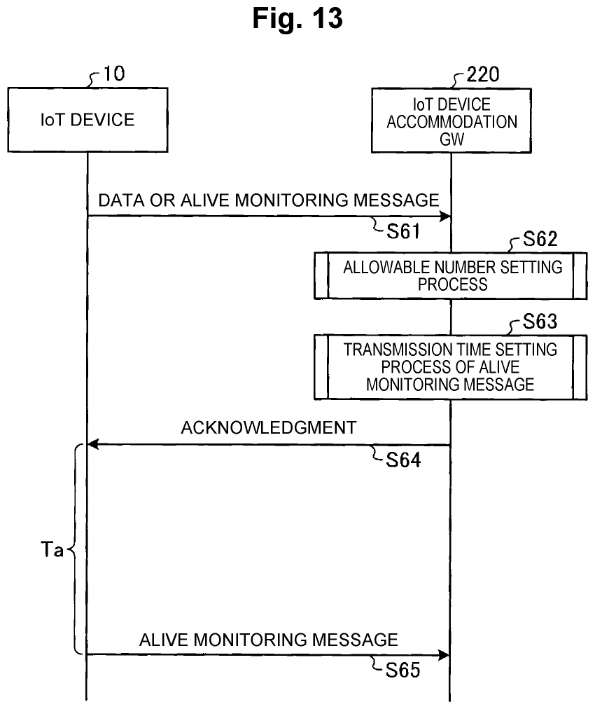

Next, a description will be made about processing procedures of the alive monitoring process in the communication system according to the second embodiment. FIG. 13 is a sequence diagram illustrating one example of the processing procedures of the alive monitoring process according to the second embodiment.

The IoT device 10 transmits the data or the alive monitoring message to the IoT device accommodation GW 20 (step S61). The IoT device accommodation GW 220 performs an allowable number setting process for setting the allowable reception number of alive monitoring messages in the unit time (step S62).

The IoT device accommodation GW 20 performs a similar process to step S2 and performs a transmission time setting process of the alive monitoring message for setting the transmission time of the alive monitoring message for the IoT device 10 (step S63). In the transmission time setting process of the alive monitoring message, the allowable reception number of alive monitoring messages, the allowable reception number being set in the allowable number setting process, is used. Step S64 to step S65 illustrated in FIG. 13 are the same processes as step S3 to step S4 illustrated in FIG. 6.

[Processing Procedures of Allowable Number Setting Process]

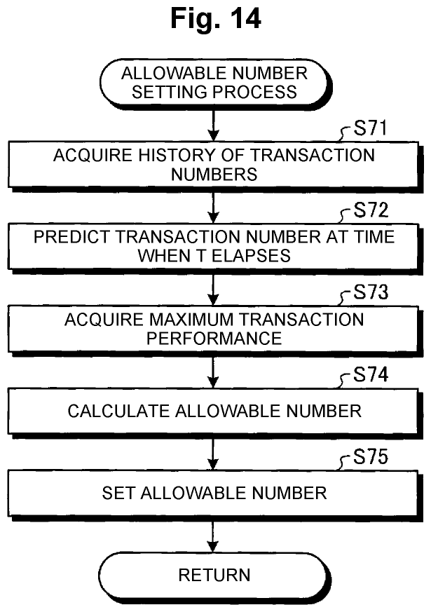

Next, a description will be made about processing procedures of the allowable number setting process (step S62) illustrated in FIG. 13. FIG. 14 is a flowchart illustrating the processing procedures of the allowable number setting process illustrated in FIG. 13.

As illustrated in FIG. 14, in the IoT device accommodation GW 220, the allowable number setting unit 226 acquires the history of the transaction numbers from the transaction management unit 225 (step S71). Then, the allowable number setting unit 226 predicts the transaction number of a time when a time T elapses, the time T corresponding to the next unit time, based on the acquired history of the transaction numbers (step S72). Then, the allowable number setting unit 226 acquires maximum performance per unit time in the IoT device accommodation GW 220, that is, the maximum allowable number of the transaction number per unit time (step S73). Then, the allowable number setting unit 226 calculates the allowable reception number of alive monitoring messages in the next unit time by using, for example, the expression (1) (step S74) and sets the calculated allowable reception number (step S75).

[Effects of Second Embodiment]

As described above, in the second embodiment, the IoT device accommodation GW 220 predicts the transaction number in the unit time as a target of setting of the allowable number based on the history of the transaction numbers, and sets the allowable reception number of alive monitoring messages in the unit time. In other words, the IoT device accommodation GW 220 predicts a load condition of the system per unit time from the history of the transaction number per day or per week, and adjusts the allowable reception number of alive monitoring messages in accordance with this load condition. Consequently, according to the second embodiment, increasing or decreasing the allowable reception number of alive monitoring messages in accordance with the load condition of the system thereby spreads the load on the IoT device accommodation GW 20 due to the alive monitoring, and enables reduction in the load on the IoT device accommodation GW 20 due to the alive monitoring.

[System Configuration and so Forth]

Configuration elements of apparatuses in the drawings are functionally conceptual elements and do not necessarily have to be physically configured as the drawings. That is, specific forms of distribution and integration of the apparatuses are not limited to the forms in the drawings, and all or portions thereof may be configured by functionally or physically distributing or integrating them in any unit in accordance with various kinds of loads, use situations, and so forth. Furthermore, as for processing functions performed in the apparatuses, all or any portions thereof may be realized by a CPU (central processing unit) and a program analyzed and executed by the CPU or may be realized as hardware by wired logic.

Further, among the processes described in the present embodiments, all or portions of the processes explained as being automatically performed may manually be performed, or all or portions of the processes explained as being manually performed may automatically be performed by a known method. In addition, process procedures, control procedures, specific names, and information including various kinds of data and parameters, which are described in the above document and the drawings, may arbitrarily be changed unless otherwise mentioned.

[Program]

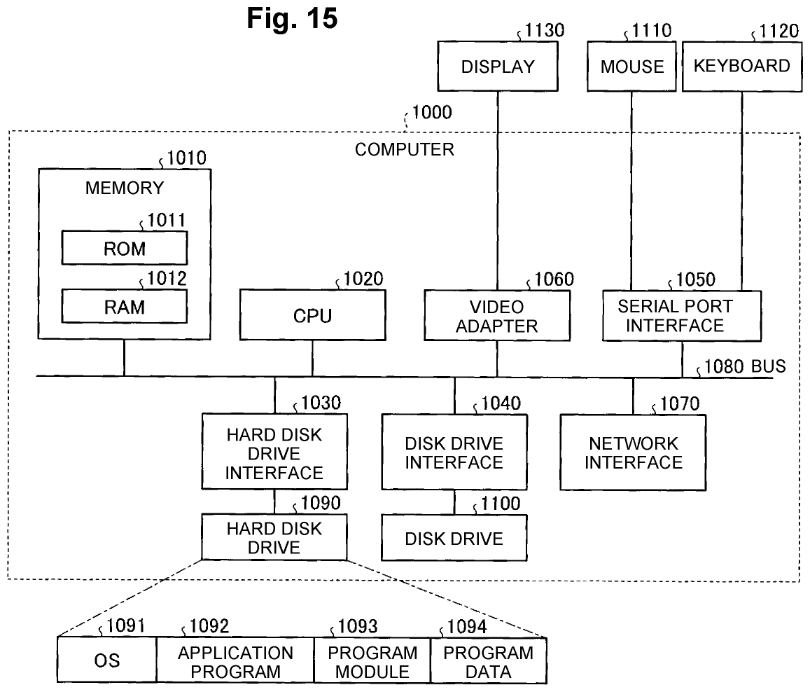

FIG. 15 is a diagram illustrating one example of a computer executing programs and thereby realizing an apparatus configuring the communication system of the first or second embodiment. A computer 1000 has a memory 1010 and a CPU 1020, for example. Further, the computer 1000 has a hard disk drive interface 1030, a disk drive interface 1040, a serial port interface 1050, a video adapter 1060, and a network interface 1070. These units are connected by a bus 1080.

The memory 1010 includes a ROM (read only memory) 1011 and a RAM (random access memory) 1012. The ROM 1011 stores a boot program such as a BIOS (basic input output system), for example. The hard disk drive interface 1030 is connected with a hard disk drive 1090. The disk drive interface 1040 is connected with a disk drive 1100. For example, a detachable storage medium such as a magnetic disk or an optical disk is inserted in the disk drive 1100. The serial port interface 1050 is connected with a mouse 1110 or a keyboard 1120, for example. The video adapter 1060 is connected with a display 1130, for example.

The hard disk drive 1090 stores an OS (operating system) 1091, an application program 1092, a program module 1093, and a program data 1094, for example. That is, a program providing each process of the apparatus configuring the communication system of the first or second embodiment is implemented as the program module 1093 in which codes executable by a computer are described. The program module 1093 is stored in the hard disk drive 1090, for example. For example, the program module 1093 for executing the same processes as a functional configuration in the apparatus configuring the communication system of the first or second embodiment is stored in the hard disk drive 1090. Note that the hard disk drive 1090 may be substituted by a SSD (solid state drive).

Further, setting data used in the processes of the above-described embodiments are stored, as the program data 1094, in the memory 1010 or the hard disk drive 1090, for example. Then, the CPU 1020 reads out the program module 1093 or program data 1094 stored in the memory 1010 or hard disk drive 1090 to the RAM 1012 as needed and executes it.

Note that the program module 1093 and the program data 1094 are not limited to a case of being stored in the hard disk drive 1090 but may be stored in a detachable storage medium and be read out by the CPU 1020 via the disk drive 1100 or the like, for example. Alternatively, the program module 1093 and the program data 1094 may be stored in another computer connected via a network (such as LAN or WAN (wide area network)). Further, the program module 1093 and the program data 1094 may be read out from another computer by the CPU 1020 via the network interface 1070.

In the foregoing, descriptions have been made about the embodiments to which the invention made by the present inventor is applied; however, the present invention is not limited by descriptions and drawings representing a portion of the disclosure of the present invention by the present embodiments. That is, all of other embodiments, practical examples, and applied techniques, and so forth made by a person skilled in the art based on the embodiments are included in the scope of the present invention.

### REFERENCE SIGNS LIST

10 IoT device
11 sensor
12 re-transmission timer
13 alive monitoring timer
14, 24 communication unit
15 data transmission trigger monitoring unit
16 sleep management unit
23 alive monitoring reception amount management unit
20, 220 IoT device accommodation GW
21 alive monitoring time management unit
225 transaction management unit
226 allowable number setting unit

1. A gateway accommodating a plurality of IoT (Internet of things) devices, the gateway comprising:
a first setting unit, including one or more computing devices, configured to set, for each of the plurality of IoT devices, a transmission time of an alive monitoring message to the gateway;
a first acquisition unit, including one or more computing devices, configured to acquire a planned reception number of alive monitoring messages by the plurality of IoT devices per unit time based on a setting content by the first setting unit;
a change unit, including one or more computing devices, configured to change the transmission time of the alive monitoring message of any IoT device of the plurality of IoT devices in a case where the acquired planned reception number exceeds an allowable reception number of alive monitoring messages; and
a communication unit, including one or more computing devices, configured to transmit the transmission time set by the first setting unit or the transmission time changed by the change unit to any of the IoT devices of the plurality of IoT devices.

2. The gateway according to claim 1, wherein
in a case where the acquired planned reception number exceeds the allowable reception number of alive monitoring messages, the first acquisition unit acquires the planned reception number of alive monitoring messages by the plurality of IoT devices for each of subsequent unit times, and
the change unit changes the transmission time of the alive monitoring message of any IoT device of the plurality of IoT devices such that the transmission time corresponds to the subsequent unit time in which the planned reception number acquired by the first acquisition unit becomes the allowable reception number of alive monitoring messages or less.

3. The gateway according to claim 1, further comprising:
a second acquisition unit acquiring a history of a transaction number of the plurality of IoT devices for each of the subsequent unit times; and
a second setting unit predicting the transaction number in the unit time based on the history of the transaction number and sets the allowable reception number of alive monitoring messages in the unit time based on a maximum allowable number of the transaction number per unit time in the gateway and the predicted transaction number.

4. A communication system comprising:
a plurality of IoT (Internet of things) devices; and
a gateway accommodating the plurality of IoT devices, wherein the gateway includes:
a first setting unit, including one or more computing devices, configured to set, for each of the plurality of IoT devices, a transmission time of an alive monitoring message to the gateway;
a first acquisition unit, including one or more computing devices, configured to acquire a planned reception number of alive monitoring messages by the plurality of IoT devices per unit time based on a setting content by the first setting unit;
a change unit changing a transmission time of an alive monitoring message of any IoT device of the plurality of IoT devices in a case where the acquired planned reception number exceeds an allowable reception number of alive monitoring messages; and
a first communication unit, including one or more computing devices, configured to transmit the transmission time set by the first setting unit or the transmission time changed by the change unit to any of the IoT devices of the plurality of IoT devices, and
wherein the IoT device includes:
a second communication unit, including one or more computing devices, configured to transmit a message to the gateway in accordance with a monitoring cycle transmitted by the first communication unit.

5. The communication system according to claim 4, wherein
in a case where the acquired planned reception number exceeds the allowable reception number of alive monitoring messages, the first acquisition unit acquires the planned reception number of alive monitoring messages by the plurality of IoT devices for each of subsequent unit times, and
the change unit changes the transmission time of the alive monitoring message of any IoT device of the plurality of IoT devices such that the transmission time corresponds to the unit time in which the planned reception number acquired by the first acquisition unit becomes the allowable reception number of alive monitoring messages or less.

6. The communication system according to claim 4, wherein
the gateway further includes:
a second acquisition unit, including one or more computing devices, configured to acquire a history of a transaction number of the plurality of IoT devices for each of the subsequent unit times; and
a second setting unit, including one or more computing devices, configured to predict the transaction number in the unit time based on the history of the transaction number and sets the allowable reception number of alive monitoring messages in the unit time based on a maximum allowable number of the transaction number per unit time in the gateway and the predicted transaction number.

7. The communication system according to claim 4, wherein
the IoT device further includes:
a management unit, including one or more computing devices, configured to cause the second communication unit to go into a sleep state in a period except for a communication time in accordance with the monitoring cycle transmitted by the first communication unit.

8. A communication method being executed by a gateway accommodating IoT (Internet of things) devices, the communication method comprising:
setting, for each of the IoT devices and by one or more computing devices, a transmission time of an alive monitoring message to the gateway;
acquiring, by the one or more computing devices, a planned reception number of alive monitoring messages by the IoT devices per unit time based on a setting content set in the setting;
changing, by the one or more computing devices, the transmission time of the alive monitoring message of any IoT device of the IoT devices in a case where the acquired planned reception number exceeds an allowable reception number of alive monitoring messages; and
transmitting, by the one or more computing devices, the transmission time set in the setting or the transmission time changed in any IoT device of the IoT devices.
